(19) United States
(12) Patent Application Publication
(10) Pub. No.: US 2008/0195462 A1
(43) Pub. Date: Aug. 14, 2008

(54) Method And System For Collecting And Correlating Data From Information Sources To Deliver More Relevant And Effective Advertising

(75) Inventors: Malik Magdon-Ismail, Loudonville, CA (US); Parag Patel, Marina del Rey, CA (US)

Correspondence Address: PARAG PATEL, 4708 LA VILLA MANNA, UNIT G, MARINA DEL RAY, CA, 90292, US

(73) Assignee: SWOOGE, LLC, Loudonville, NY (US)

(21) Appl. No.: 12/104,899

(22) Filed: Apr. 17, 2008

Related U.S. Application Data
(63) Continuation-in-part of application No. 11/552,268, filed on Oct. 24, 2006.
Application No. 11/552,268 is a continuation-in-part of application No. 11/677,172, filed on Feb. 21, 2007.
(60) Provisional application No. 60/912,907, filed on Apr. 19, 2007.

(51) Int. Cl. G06Q 30/00

(52) U.S. Cl. 705/10; 705/7; 705/14

(57) ABSTRACT

A method and system for collecting and using in combination data from information sources in a correlated manner to deliver more relevant and effective advertising is provided. Website owners register with a service provider, submit relevant information about their website and download website analytics software enabling relevant data to be tracked by and transmitted to the service provider's online database. Service provider also collects data from other information sources including an online website exchange, webcrawlers and other software (e.g. toolbars, cookies, javascript) that track the navigation history of individual Internet users and their demographic information. Service provider correlates and analyzes submitted data from some or all of the information sources to determine scores, meaningful ranking and other useful information regarding the efficacy of websites for potential advertisers. Potential advertisers perform search requests on the service provider's database using advertiser-specific parameters to retrieve a portfolio of advertising opportunities that are optimally matched with the advertiser's specifications. The advertisers may edit the results and submit a request via service provider to the one or multiple website owners to implement the portfolio of resulting and/or revised advertising opportunities.

### CROSS-REFERENCE TO RELATED APPLICATIONS

This Application is a continuation in part of U.S. patent application Ser. No. 11/552,268 (filed on Oct. 24, 2006) and U.S. patent application Ser. No. 11/677,172 (filed on Feb. 21, 2007). The entire disclosure of these priority applications is hereby incorporated by reference herein. This Application also claims priority to U.S. Provisional Patent Application 60/912,907 filed on Apr. 19, 2007 and entitled Method And System For Collecting And Correlating Data From Information Sources To Deliver More Relevant And Effective Advertising.

### BACKGROUND OF THE INVENTION

1. Field of the Invention

The present invention generally relates to online advertising systems and methods used to facilitate the introduction of online advertisers to suitable online website owners for purposes of conducting more effective online advertising and/or marketing campaigns.

2. Background of the Invention

Worldwide use of the Internet is growing at an extremely rapid pace. Millions of people worldwide use the Internet daily for accessing information, shopping, recreation, receiving product updates, and other communications. As computers and Internet access become less expensive and easier to use, use of the Internet will become even more widespread.

As a result, many start-up and established companies and others (“Advertisers”) increasing view the Internet as a profitable place to advertise their goods and services and many owners of websites and other web properties (“Owners”) are finding that increased traffic on their websites translates to additional revenue and seek to take advantage of such opportunity.

However, given the seemingly infinite size of the Internet, the time constraints on Advertisers to find suitable Owners (and vice-versa), the time and expense of hiring third party marketing firms and the time taken by such firms to implement a marketing campaign, it remains an administrative burden for suitably-matched Owners and Advertisers to find each other and implement multi-faceted (i.e. involving several Owners, search engines and the like) marketing campaigns. Moreover, with the increasing sophistication and costs of online marketing, Advertisers need detailed information (e.g. advertising fees, traffic, repeat customers, conversion rates) about Owners to determine the effectiveness of a marketing campaign before engaging in such.

Hence, a method and system is needed that facilitates the introduction of Advertisers to Owners, collection of relevant information, transfer of data analysis of such information from Owners to Advertisers, implementation of Advertiser's marketing campaign and feedback to Advertisers on the effectiveness of their campaign.

### DETAILED DESCRIPTION OF THE INVENTION AND PREFERRED EMBODIMENTS

The following presents a method and system for collecting and using in combination data from some or all of various information sources in a correlated manner to deliver more relevant and effective advertising.

The information sources include: (i) an online website exchange which provides information such as “prices” of websites, trading volume, demographics of traders, historical behavior; (ii) navigation tracking software (e.g. Alexa toolbar), which provide information such as traffic statistics for a website, browsing patterns before arriving on and after leaving website, browser demographics to website; (iii) webcrawlers, which provide information such as website content, website interconnectivity; (iv) website analytics solutions, which provide information such as traffic statistics for a website, browsing patterns on websites, key word searches leading to website; and (v) navigation tracking software as in (ii), but which is dedicated to collecting information regarding the online activities of participants engaging in an online website exchange as is (i), which provides information such as what traders are trading and simultaneously what types of websites they visit. This description of what types of data each information source provides is intended for illustrative purposes only and not as a limitation. Those skilled in the art may configure the information sources to obtain other types of data.

In the website exchange, traders make their buying and selling decisions based on historical, current and predictive market data related to the success of the website, on both the website exchange and in reality. The market data is gathered from the website exchange and the online trade of the fictitious shares of stock of a plurality of websites and may further comprise external data related to factors that may include without limitation popularity, fad, earning capability, website-related events and business-related events.

The website exchange simulates an actual stock exchange wherein the incentive to buy a fictitious share of stock is the expectation of a future return, which the trader may attempt to predict by analyzing market data. For example, it is profitable for the trader to own a fictitious share at a current market price that is below a predicted market price, and the expectation is that the fictitious share does indeed reflect an expected future return based on the predicted market price of the fictitious share with regard to the website. The future return may also be in the form of a dividend that is paid to the traders holding the fictitious shares of a specific website for which a dividend may be payable. Thus, the market data may correlate to an accurate prediction of the future success of the website. A more detailed description of such an online website exchange is described in U.S. patent application Ser. No. 11/677,172 (filed on Feb. 21, 2007).

Data collection using navigational tracking software (e.g. the Alexa toolbar, cookies, javascript, adware) and webcrawlers (e.g. Google crawlers) are well-known in the art. Companies that collect data in this manner (e.g. Alexa) often sell such information to advertisers and other companies. Alternatively, or in addition, researchers release their own versions of toolbars and crawlers to collect information. Similarly, website analytics solutions (e.g. Google Analytics) are well-known in the art and enable website owners to monitor, among other things, how visitors arrive, navigate around and leave websites.

A specific navigational tracking software that also monitors the online activities of website exchange participants (“Toolbar”) is described in greater detail in U.S. patent application Ser. No. 11/552,268 (filed on Oct. 24, 2006). U.S. patent application Ser. No. 11/552,268 describes methods and apparatus to monitor an Internet user's navigational history and enabling such user to enter bids on relevant goods or services using a toolbar or other similar browser software. This “on the fly” optimization method is specific to a given user. Merchant and/or auction web sites are provided with the bidding information and may accept or decline the bid. As described below, the combination of information from a website exchange (what a trader thinks) with navigational history (where the trader is going and what he or she is looking for) presents an example of correlated data that is useful in determining which advertisement or bidding opportunity to present to the trader. Toolbar users may also rate and write reviews for Owners websites; however such data will be treated in accordance with rater trustworthiness. For example, frequent raters will be given scores based on how their ratings match with future performance of the websites, thereby further refining the trustworthiness evaluation.

The intent behind the method is to use some or all the data from traders on the website exchange, surfers on Toolbar and websites which are monitoring their traffic to correlate who is going to which websites and what is their “state of mind”. In general, by analyzing the portfolios of traders together with current “hot stocks”, trader biases and market trends can be predicted. Based on which other sites traders visit, correlations between specifically traded sites and other “fat-tail” untraded sites may also be predicted. In addition, based on user demographics and web-analytics information, the traffic statistics and correlations between such traffic for various websites (e.g. which demographics are attracted to a group of websites) may also be predicted. Hence combining some or all of this data together, more relevant contextual information and more effective advertising opportunities may be offered to advertisers.

The following are examples of how data from some or all of the above information sources may be correlated to deliver more relevant and effective advertising. These examples are provided for illustrative purposes only, and not intended to be limitations on how data from the information sources can be correlated to provide information on intelligent online advertising.

(1) Price as a Market Prediction: Websites with high trading volume and price rise are indicative of trends. Such websites constitute cheap advertising opportunities if their website exchange price or trading levels are trending higher, but their current advertising rates are based on lower historical traffic data. In addition, the demographics of individuals trading these websites indicates which products to advertise on those websites. For example: If Gap website price is very high (i.e. predicting a dividend greater than historical traffic would indicate) and advertising rates have not yet increased accordingly, then advertising on Gap is relatively cheap. In addition, portfolio and demographic information of individuals trading the Gap website provides advertisers with intelligent information on what to advertise on the Gap website.

(2) Correlated Trend Analysis:
(a) Websites whose prices are moving in a correlated manner provide “double hit” advertising opportunities; in other words, surfers who visit one website are likely to have a similar “state of mind” to those who visit another positively correlated website. Thus an advertiser seeking to brand its product to a target demographic audience should advertise it on both sites. For example: If Gap and Pottery Barn prices are behaving in similar fashion, then an advertisement tailored for one website should be placed on the other (a positive correlation does not, however, mean that both website prices are increasing; both prices could be decreasing, but still be identified together because similar phenomena are causing the website prices to move in the same way).
(b) Websites whose prices are not correlated or anti-correlated also provides intelligent information. For example: If Gap and Technophobia are moving in an uncorrelated fashion, it suggests that different groups of traders are interested in these two websites; hence advertising on uncorrelated websites to reaches a wider audience (i.e. correlated websites are good for branding, whereas advertising on uncorrelated websites is better for hitting a wider audience (volume selling)).
(c) Positively correlated groups of websites (using clustering analysis of the correlation matrix) identify which group of websites a specific website owner should advertise to increase its traffic to “pre-disposed” surfers, thereby improving conversion rates.

(3) Inferential Demographic & State of Mind for Fat-Tail Websites: A website trader's portfolio composition, portfolio performance and relative volume of shares traded indicate his or her “state of mind”. When a group of similarly minded traders visit a “fat-tail” website (i.e. non-traded website), common trading patterns and demographic information of those traders indicate the “state of mind” of general visitors to the fat tail website and hence provide intelligence on which (i.e. more relevant) advertisements to place on that website. For example: If webtrader visiting www.xxxxxx.com, a non-traded fat tail website, are significantly long in technophile.com webshares, placing advertisements for technology products on www.xxxxxx.com would be recommended.

(4) Correlated Traffic Analysis: Given that a particular advertisement hits home after a certain number (e.g. 2) of impressions, one or more of the above methods would be used to identify where to advertise the product and use correlated analysis to place the advertisement so that surfers who see the advertisement once are likely to see it twice. As an example: Suppose surfers who visit xxx.com also visit yyy.com. Further traders who visit xxx.com and yyy.com are long in their portfolios the webshare technophile.com. A certain technology product TechWare has an advertisement which needs 2 impressions to generate a hit will be thus placed on xxx.com *and* yyy.com. In this example, correlation in the traffic of users is used to determine (for example) branding opportunities. In example (2) correlation between prices on the website exchange is used.

(5) Correlation-Based Ranking of Groups of Websites: Quantitative ranking of groups of websites based on correlation analysis and advertiser needs provides further intelligence. Typical ranking methods for websites rank properties of individual websites in isolation of the other websites (e.g. traffic based rankings). For advertising purposes, depending on advertiser needs (e.g. branding vs. volume selling) rankings of groups of websites incorporating correlation information (i.e. a ranking of advertising bundles) are provided. For example, for volume selling purposes, it may be better to advertise on www.amazon.com and www.rarebooks.com (similar product, but uncorrelated websites), whereas it would be inferior to advertise on www.amazon.com and www.bamesandnobles.com (similar product and correlated websites) because surfers would typically visit both of these latter two sites. Thus, in this example, the pair (amazon.com, rarebooks.com) would have a higher group ranking than the pair (amazon.com, barnesandnobles.com) despite barnesandnobles.com having a higher individual ranking than rarebooks.com.

(6) Financial and Mathematical Risk-Return Optimization of Advertising Portfolios: Quantitative rankings as in (5) can be used to construct the risk-return efficient frontier and offer advertisers a choice of portfolios. The advertiser may then determine which portfolio to select based on its risk-return profile. For example if advertising on barnesandnoble.com and amazon.com will yield about 50 click throughs most of the time but advertising on amazon.com and rarebooks.com will yield 25 clicks 50% of the time and 100 clickthroughs 50% of the time respectively, then the former advertising bundle has lower average performance but also lower risk, whereas the latter is more risky but with potentially much larger payoff.

### The Matching Process

Typical online advertising marketplaces require Owners to register their websites with that marketplace and submit general information about their websites (e.g. nature of goods, services, content, average age, gender, income-level of customers, average purchase price, online uptime, preference for types of advertisers, traffic statistics, etc.) and preferred advertising terms (e.g. amount of fees, whether fees are based on a “pay-per-click”, “pay-per-impression”, etc.).

Potential Advertisers perform search requests at these marketplaces using Advertiser-specific parameters. The results are typically conveyed to the Advertiser in a spreadsheet format and may contain, depending on Advertiser's preference, a certain number of or all matched website owners. Depending on the number of owners registered with the marketplace, the total number of matches could be in the thousands or hundreds of thousands, which may or may not constitute much use to the Advertiser depending on Advertiser's objectives. In any case, Advertiser must perform its own analysis and due diligence on the results.

In one embodiment of the present invention, correlated data and/or analysis may be sold directly to advertisers or other interested parties, who query the central database. In another embodiment, the website analytics data and analysis may be used to provide intelligent matching in an online marketplace. In such a marketplace, Owners and/or Advertisers may provide website data to the marketplace service provider (“Service Provider”) directly from the Service Provider's or some other reputable third party website analytics solution that tracks (using cookies, and other internet tracking tools that are commonly known in the field) customer data (e.g. age ranges, sex, preferences for goods, income levels, website traffic, position and number of click-throughs, hits based on placement of advertisements, color and other graphic properties of advertisements, nature of content and type of website, successful sales on Advertisers website based on traffic from Owners websites, effectiveness of price differentials between different types of advertisements (e.g. banner ads, pop-ups, tower advertisement and the like) on Owners' and Advertisers' websites and the like).

The website analytics solution may also verify, audit and/or generate new data regarding an Owner's submitted information (for example, by surveying the customers and advertisers (see above), monitoring online time, etc.). By employing such data, an Advertiser's search results may, in the preferred embodiment, be further narrowed and enable Advertiser to refine the match results into a more effective advertising opportunities portfolio.

In a second preferred embodiment of the Invention, Service Provider takes the process further by combining the website analytics data with data derived from other information sources (e.g. website exchange, navigational data, user ratings, webcrawlers, third party data (e.g. Alexa) etc.) and performing correlation analysis to determine meaningful rankings of the Owner websites based on their effectiveness. For example, the Service Provider may compute a score (“Score”), akin to a FICO score, that is assigned to each Owner website based on the analysis of tracked data obtained directly about the Owner (e.g. from Advertisers who received traffic from the subject Owner website, past reliability of the Owner website (uptime, past breaches, etc.), traffic data, Owner's general pricing schemes and space availability, willingness to share Owner's website performance data, willingness not to charge for non-human generated traffic (e.g. robots)) and from correlated data from other information sources (e.g. market price of positively correlated websites, user navigation history and demographics) relating to that Owner's website.

The Score is one of several factors used to determine the ranking of a specific Owner with respect to a particular Advertiser request. At the matching stage, other factors that are more attuned to the specific Owner/Advertiser compatibility (e.g. past performance of Owner's website with respect to good and services similar to those of the present Advertiser, correlated data information from the website exchange, availability of better advertisement placement, etc.) are also considered and could rank a lower Score Owner above a higher Score Owner. Hence a Score is based solely on an Owner website (and varies over time) while a ranking is based on Owner/Advertiser compatibility and may change for any given search at any given time. It is expected that, as more data is collected from Owners and Advertisers and as enhanced versions of software (to accommodate and track newly learned customer patterns) are employed, Service Provider's Score and ranking computations will yield more accurate results and will lead to more effective portfolio recommendations.

Hence, in the second preferred embodiment using Scores and rankings, an Advertiser may choose to obtain an enhanced portfolio of advertising opportunities that are derived using Service Provider's probabilistic, comparative and statistically analysis of the Advertiser's parameters (budget, time, placement, type of goods/services, etc.), Owner's Score and ranking. This customized “enhanced” portfolio would comprise of a portfolio of advertising opportunities (e.g. a combination of banner and tower advertisements on a manageable number of different websites at varying times, submissions to pay-per-click text advertisements to search engines, etc.); a few alternative portfolios may also be suggested depending on the Advertiser's goal (to reach a broad audience for branding purposes (better served by advertising on non-correlated website) versus targeting and selling to a specific demographic (better served by advertising on highly correlated websites). In all versions of the Invention, Advertisers may edit the portfolio results, upload their advertising material and submit a single request via Service Provider to the one or multiple Owners to implement the advertising campaign. Owners then have an opportunity (if they so elect) to approve or disapprove the advertising opportunity. Owners may also allocate certain blocks and times of advertising space and placements to Service Provider so that Service Provider may re-allocate such advertising space and placements to Advertisers (thereby relieving Owners of the burden of seeking Advertisers and allocating advertising space themselves).

By this method, Advertisers can conduct a search, find a statistically optimal multi-faceted online marketing campaign for their goods and/or services and implement their campaign involving multiple advertising outlets within a matter of minutes and from a single source. In addition, Advertisers have access to information about a particular website's statistically-backed effectiveness as to specific goods and/or services beforehand, thereby simplifying their decision-making process. Finally, Owners can use their Scores and other data gathered by Service Provider to improve the advertising efficiency of their websites (thereby also benefiting customers). More importantly, Owners also get access to advertising opportunities and/or have the choice of completely or partially outsourcing their entire advertising-related administration (timing, placement, tracking, collecting, etc.) to Service Provider.

As noted above, Owners typically download Service Provider's tracking and auditor software for purposes of having Service Provider track, verify and/or audit statistics generated by Owners' website properties. This may cause security concerns on the part of several Owners. To alleviate such concerns, Owners may chose not to download Service Provider's software and only enter their own information on a regular basis. Websites belonging to such Owners may or may not be presented to Advertisers and, if presented, their Scores and ranking may be considerably weakened in determining their suitability for advertising. Another solution may be for Owners to permit Service Provider to create a “mirror” of all or a portion of their websites, so that the Owner's website traffic is directed to Service Provider's website (which contains the tracking software), thereby enabling tracking of customer activities without forcing Owners to download the software. These methods are intended to provide examples of how Service Provider may alleviate security concerns of Owners, and not as a limitation of the scope of how such security concerns may be alleviated.

### Incentivizing Website Exchange Participants

Studies show that predictive markets generally provide accurate results by gathering the “collective wisdom of the crowd”. The information derived from the website exchange contributes significant predictive data to the correlated data analysis in the various manners described above. However, to obtain accurate and reliable predictive markets data, there needs to be a sufficient number of participants and those participants need to engage in intelligent and non-arbitrary trades. Hence there exists a need to incentivize internet users to become predictive markets participants and then to trade intelligently and non-arbitrarily. This need exists in all predictive markets, not just those involved in the trading of websites.

The following are methods and apparatus intended to incentivize internet users to become participants in all types of predictive markets (not just those involved in the trading of websites) and then to trade intelligently and non-arbitrarily. Generally, in predictive markets simulations or games, participants are given an arbitrary amount of fictitious currency to trade and top traders and/or contestant winners are awarded cash and other types of prizes.

In one embodiment of the present invention, website exchange participants are provided the option of downloading the combined website exchange-navigation history tracker (number (v) information source, or the “Toolbar”) in exchange for bonus fictitious currency. They are also offered the option to accumulate additional bonuses on an ongoing basis if they permit the Toolbar to track their internet activity (a stop-tracking button may be provided for privacy concerns if users wish to disable tracking on a temporary or permanent basis). Participants use their initial and bonus fictitious currency to trade. If they make a profit, they accumulate points (or some other measurable denomination of success) which they can redeem for cash, discounts, airmiles or some other form of consideration. Hence the more initial currency a participant obtains (through signing up, downloading Toolbar, permitting tracking of his or her online activities, recruiting other participants (see below)), the greater his or her ability to generate a larger profit, and consequently to realize a larger cashback and/or other reward.

To encourage a participant to recruit others to participate, he or she may receive bonus fictitious dollars for referrals who sign up, with increasingly bigger bonuses if the referrals also download the Toolbar and permit tracking. Further, the referrer may receive additional bonuses if his or her referrals also generate positive returns on the website exchange (thereby incentivizing the entire group of referror and his or her referrals to play intelligently and non-arbitrarily). Referrals can also obviously refer others, creating their own referror-referrals group.

Bonuses may be further conditioned on (or the amount varied based on) verifiable demographics of referrals (e.g. higher bonuses may be offered to attract referrals with certain attributes, such as specific age groups, gender, residence, income levels, education level, etc.) To limit fraudulent sign-ups, whenever desirable, specific attributes and/or amount of bonuses may not be disclosed (e.g. only general statements relating to need for diversity may be made and/or past examples of bonuses based on diversity may be posted), thereby causing participants to refer a diverse group of referrals without informing potential referrals how to identify themselves fraudulently in order to obtain bonuses.

Caps on payouts and/or other precautionary measures (e.g. limiting bonuses to a referror to a certain number (e.g. 2) of levels down the referral chain, limiting number of referrals, etc.) may be instituted to optimize the balance between number of participants, intelligent playing and the cost to recruit such individuals. Fraudulent play (e.g. teaming with others to manipulate a website price by driving it high or low) may be reduced, if not eliminated, by paying bonuses to any referror-referrals group only for net total increases (although disassociations may be permitted under genuine circumstances) and/or limiting the number of accounts (by IP address or other techniques well-known in the art) to any one participant. An added advantage of basing bonuses on net increases in a markets settings is that one player's losses may offset's another's winnings, thereby limiting the amount of bonuses paid.

In addition to getting bonuses for rewards, participants using Toolbar are also presented with bidding opportunities and may use their accumulated points to bid for and/or obtain discounts on goods or services for which the participant is actively seeking. Accordingly, participants have an incentive to play the game in an intelligent, non-arbitrary manner and to permit tracking by the Toolbar. Additionally, the Toolbar not only provides information (e.g. current or historic website price, ability to rate a website) to participants regarding websites that they are currently visiting, but also provides participants with a sense of belonging and satisfaction that they are part of the website exchange, supplying information to it and increasing the relevancy of advertisements in general.

Apparatus that may be used to perform the above tasks include computers with memory and processors driven by software configured to perform those tasks and access to online communication networks such as the Internet. Detailed description of such apparatus may be found in U.S. patent application Ser. No. 11/677,172 (filed on Feb. 21, 2007), whose entire disclosure is incorporated herein.

### BRIEF DESCRIPTION OF THE DRAWINGS

FIG. 1 illustrates various aspects of the invention and some its embodiments. It should be made clear that FIG. 1 does not limit the scope of the invention, and is intended merely to describe some of the main features of the invention.

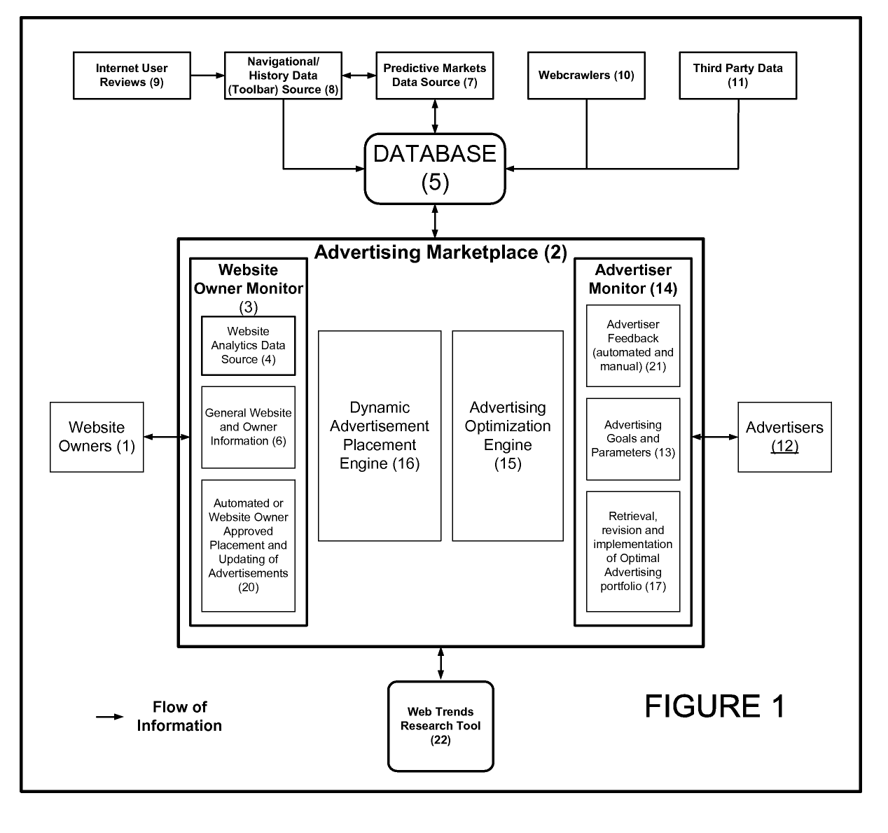

### DETAILED DESCRIPTION OF THE FIG. 1

Website Owners (1) register on the Advertising Marketplace (2). Through a Website Monitor (3) interface to the Advertising Marketplace (2), Owners use website analytics software (4) to provide traffic and other tracked data directly to the Database (5). Website Owners (1) also use the Website Owner Monitor (3) interface to provide General Website and Owner Information (6) (e.g. Website content, Owner's preferences and other website information) to the Database (5). Thus data retrieved by the Website Monitor (3) is relayed to and updates the Database (5).

The Database (5) also retrieves data from other sources, including a simulated predictive market for website exchange (7), Toolbar (8), internet user reviews (from Toolbar)(9), webcrawlers (10) and third party databases (11) (e.g. Alexa).

Advertisers (12) register on the Advertising Marketplace (2) and input their Advertising Goals and Parameters (13) using via an Advertiser Monitor interface (14). The Advertising Optimization Engine (15) segment of the Advertising Marketplace (3) retrieves information from the Database (5) and the Dynamic Advertisement Placement Engine (16) to compute an available Optimal Advertising Portfolio (17) that may be accessed, edit, approved and implemented by the Advertiser Client (18).

An Advertiser (12) may refine and/or edit the optimal portfolio and/or its Advertising Goals and Parameters (13) before it submits the optimal portfolio for implementation to the Dynamic Advertisement Placement Engine (17) segment of the Advertising Marketplace (2). Website Owners (1) may then accept or reject the advertising opportunity (20) via their Website Owner Monitor (3) interface. If an opportunity is rejected by one or more Website Owners (1), the Advertising Optimization Engine (15) may adjust that portion of the portfolio and send the entire new adjusted portfolio to the Advertiser (12) for re-approval. It should also be noted that the approval process by both Website Owners (1) and Advertisers (12) depends on their preferences (ranging from mandatory approval to complete automation), although multiple rejections by Website Owners (6) may adversely affect the number of future opportunities presented to them.

Based on Advertiser feedback (21) (both automated (e.g. number of conversions, click-throughs) and manual (advertiser reviews of websites), the Advertising Marketplace (2) continuously re-computes more effective strategies, thereby providing not only feedback to Website Owners (1), but also real-time optimized solutions to the Advertisers (12). In addition, Advertisers (12) or other web trends analysts may query the Advertising Marketplace (2) and Database (5) using a Web Trends Research (22) tool interface to retrieve and analyze data in order to discern web trends.

### Analysis of Tracked Data

As indicated above, the second preferred embodiment contains a further step of analysis. The analysis is based on the system's ability to learn to predict the profitability Score and ranking of a website. As Service Provider's data base matures, it will continue to collect statistics on the Website Owners (1) as follows:
Website content data
Website usage statistics
Click efficiency for ads based on
   Position in website
   Type of advertisements (including, but not limited to banner, popup and image advertisements)
Percentage overlap index for ad with respect to website content
Price data on the website exchange for correlated websites.
Correlations in traffic on this website with traffic on other websites.
other collected data

Those in the art are familiar with various optimization techniques that may be used to manipulate the collected data; while the technique provided below may be used to optimize results in accordance with the invention, other techniques may be obvious to those with ordinary skill in the art; accordingly, the below is provided for illustrative purposes in order to show how to enable the invention, and not as a limitation to the invention itself.

These statistics form a data base that evolves with time. For a new candidate advertisement from an Advertiser (12) for a candidate Website Owner (1) Service Provider will form a set of predictive variables based on the following input parameters:
Website statistics input variables (based on above data): X1,X2,X3 . . .
Compatibility variables for target ad to website: Y1,Y2,Y3, . . .
   Such compatibility variables may include:
      Website demographics match to ad target demographic
      Website content match to ad content
Position and type of ad variables: Z1,Z2, . . .

In a preferred embodiment, an artificial intelligence (AI) learning method will learn a functional representation between the input variables (X1,X2, . . . , Y1,Y2, . . . , Z1,Z2 . . .) and the probability that the advertisement is clicked by a user who navigates to the Client (1) website. This probability can be represented as

Probability=ƒ(X1,X2, . . . , Y1,Y2, . . . , Z1,Z2 . . .),

where the function ƒ is to be learned from the historically collected data. This historically collected data is formed by constructing the variables X1,X2, . . . , Y1,Y2, . . . , Z1,Z2 . . . for already placed ads on given websites and obtaining the historically computed probability of a click through. In this way Service Provider builds a data base for all the already placed advertisements with data points of the form:

(X1,X2, . . . , Y1,Y2, . . . , Z1,Z2, . . . , Estimated Historical Probability)

The function ƒ is to be determined by performing a fit to the data and attempting to find the best fit function ƒ which most accurately predicts the Estimated Historical Probabilities from the historical variables X1,X2, . . . , Y1,Y2, . . . , Z1,Z2, . . . ,. A variety of tools already exist in AI machine learning to perform such fits ranging from non-parametric models (Kernel estimators) to parametric models (Linear regression, neural networks, support vector machines, clustering based classification algorithms such as radial basis function networks) (see for example [Bishop: Neural Networks for Pattern Recognition], [Duda and Hart: Pattern Classification]).

The learned function ƒ will be continually updated based on the arrival of new data. The function ƒ will be used to determine the potential profitability of any target advertisement of the Client (6) on a potential Owner (1). These potential profitabilities will be used by the Advertising Optimization Engine (15) in determining the optimal advertising portfolio offered to the Advertiser (12).

What is claimed is:

1. A method for improving advertising effectiveness of online properties, the method comprising the steps of:
receiving data from at least two information sources;
processing said data to generate correlation results; and
using said correlation trends to determine advertising effectiveness at least one online property.

2. The method of claim 1, wherein the information sources include at least two of predictive markets, website-based navigation tracking software, webcrawlers, website analytics solutions, Internet User Reviews, Owner-supplied information and online website exchange participant-based navigation tracking software.

3. The method of claim 1, further comprising the steps of:
receiving Advertiser-specific parameters from an Advertiser;
computing and dynamically updating said advertising effectiveness of at least one online property with respect to said received Advertiser-specific parameters;
providing an enhanced portfolio of advertising opportunities to said Advertiser.

4. The method of claim 3, further comprising the step of:
implementing an advertising campaign based on said enhanced portfolio of advertising opportunities; and
providing feedback to Advertiser based on results from said advertising campaign.

5. The method of claim 4, further comprising the step of allowing said Advertiser to edit said enhanced portfolio of advertising opportunities.

6. A method to recruit internet users to join a predictive markets game and play it intelligently and non-arbitrarily, the method comprising the steps of:
signing up initial participants for a predictive markets game by offering awards in exchange for fictitious currency earned by successful trading activity;
requesting said initial participants to recruit other participants by providing at least one of the following incentives:
receive bonus fictitious currency for referral participants who sign up for said predictive markets game;
receive bonus fictitious currency if said initial participants or their referral participants permit user-based navigational tracking;
receive bonus fictitious currency if said referral participants generate positive returns on said predictive markets game;
receive bonus fictitious currency for referral participants of a certain demographic-type; or
receive bonus fictitious currency if said referral participants recruit additional referral participants; and
providing awards to participants based on redemption of fictitious currency earned by successful trading activity and by said bonuses.

7. The method of claim 6, further comprising a step of limiting bonuses of fictitious currency based on at least one of the following:
limiting bonuses of currency based on a pre-determined number of levels down the referral participant chain;
limiting number of referrals per participant;
limiting bonuses of fictitious currency to participant-referral groups only for net total increases; and
limiting the number of accounts per participants;

8. A system for improving advertising effectiveness of online properties, the system comprising:
a host server configured to receive and transmit data from information sources over a global communications network, the host server including:
a Website Owners Monitor interface configured to direct communications received over the global communications network between the host server and a Website Owner device;
an Advertiser Monitor interface configured to direct communications received over the global communications network between the host server and an Advertiser device;
a Database configured to store information from at least one information source;
a Dynamic Advertisement Placement engine configured to receive data from said Database and said Website Owner Monitor, said data being used to calculate the advertising effectiveness value for at least one online property; and
an Advertising Optimization Engine configured to receive data from said Advertiser Monitor and advertising effectiveness values from said Dynamic Advertisement Engine, said data and advertising effectiveness values being used to compute an enhanced portfolio of advertising opportunities.
